(19) United States
(12) Patent Application Publication
(10) Pub. No.: US 2012/0103119 A1
(43) Pub. Date: May 3, 2012

(54) ELECTRICALLY CONTROLABLE TRANSMISSION FOR CONTROLLING THE STIFFNESS OF A VEHICLE SHOCK ABSORBER

(76) Inventor: Cheng-Da Lin, Toayuan City (TW)

(21) Appl. No.: 12/938,366

(22) Filed: Nov. 2, 2010

(51) Int. Cl. F16H 1/14

(52) U.S. Cl. 74/417

(57) ABSTRACT

A transmission mechanism for electrically controlling the stiffness of a vehicle shock absorber comprises an actuator assembly, a transmission assembly, and an electronic controller. The transmission assembly comprises a step motor, a steel wire assembly, and a transmission control component. The transmission control component comprises a fixing nut, an outer casing body, a secondary bevel gear, and a main bevel gear. The outer casing body holds the main bevel gear and the secondary bevel gear, which are installed inside the outer casing body in the manner that they are engaged with each other and can freely rotate relative to the outer casing body. Inside the fixing nut are disposed spiral threads to be screw locked to the top of the shock absorber. The flexible steel wire is connected on one end with the step motor and on the other end with the secondary bevel gear to transmit the rotation of the motor. The design of this transmission mechanism allows the step motor to adjust the stiffness of the shock absorber without having to be installed on top of it. It reduces the volume and height of the shock absorber, decreases the required installation space, and enhances the applicability and efficiency of the shock absorber.

### BACKGROUND OF THE INVENTION

1. Field of the Invention

The present invention relates to a transmission mechanism for electrically controlling the stiffness of automobile and motorcycle shock absorber and particularly to a transmission mechanism which electrically controls the stiffness of shock absorber with the use of a flexible steel wire to connect and transmit motor revolution.

2. Brief Description of Related Art

It is a common practice nowadays to install shock absorbers in automobiles or motorcycles to alleviate the shock caused by bumpy road surfaces. This not only increases the comfort of drives but also effectively lengthens the service life of vehicles.

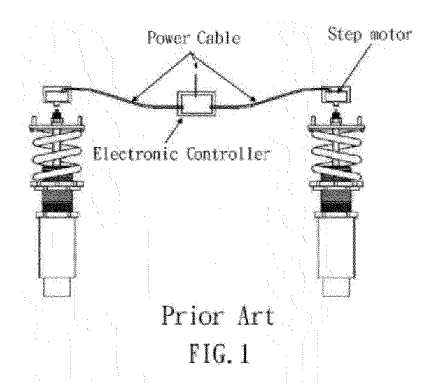

Prior shock absorbing constructions were all mechanical. Stiffness adjusting mechanisms were all disposed on top of shock absorbing constructions and were manually adjusted and fixed. But this was not convenient enough in terms of adjusting shock absorbing constructions to provide the desired degree of comfort. To achieve better shock absorbing effects, electronic regulators have been designed to replace prior manually setup products. To conveniently adjust the stiffness of shock absorbing constructions, the electronic controlling parts in all existing electronic shock absorbers directly control and propel the step motors installed right on top of the shock absorbing constructions (See FIG. 1). As the large installation space on top of the shock absorber needed for the oversized motor (30-40 mm in height) gradually fails to meet the requirement of streamline vehicles, existing electronic shock absorbers can only be installed in less than 20% of current vehicle models.

If the step motor is not installed right on top of the shock absorbing construction, the installation space needed for the shock absorbing construction will be greatly reduced, and the shock absorbing construction can as a result fit into a lot more vehicle models, effectively increasing its applicability and efficiency. How to realize this purpose effectively is what needs to be researched.

In view of the foregoing considerations, the present invention attempts to solve the foregoing problems and improve the foregoing disadvantages.

### SUMMARY OF THE INVENTION

It is an object of this present invention to provide a transmission mechanism for electrically controlling the stiffness of automobile and motorcycle shock absorber, therein the step motor is moved from the top of the transmission mechanism to its outer side. This effectively reduces the required installation space by reducing the volume and height of the transmission mechanism, and increases the applicability and efficiency of the transmission mechanism for electrically controlling the stiffness of automobile and motorcycle shock absorber.

It is a further object of the present invention to provide a transmission mechanism for electrically controlling the stiffness of automobile and motorcycle shock absorber with the use of a flexible steel wire to connect and transmit the revolution of the step motor. It employs bevel gear to adjust stiffness, in place of a motor on top of the transmission mechanism commonly employed nowadays. This reduces both the volume and height of the driving device on top of the shock absorber, reducing its required installation space.

With the above objects in mind, the present invention is a transmission mechanism for electrically controlling the stiffness of automobile and motorcycle shock absorber, which includes an actuator assembly, a transmission assembly, and an electronic controller.

The transmission assembly includes a step motor, a steel wire assembly, and a transmission control component. The step motor is usually installed on the periphery of the electronic controller, forming an electronic controller module structure. The transmission control component includes a fixing nut, an outer casing body, a secondary bevel gear, and a main bevel gear. The outer casing body includes the first housing cavity and the second housing cavity, therein are disposed respectively the main bevel gear and the secondary bevel gear. The two sets of bevel gear are installed in the outer casing body in the manner that they are engaged with each other and allowed to freely rotate relative to the outer casing body. On the outer surface of the first housing cavity are disposed spiral threads to be bolted to corresponding ones disposed on the inside surface of the fixing nut. The steel wire assembly is connected to the step motor on one end and the secondary bevel gear on the other.

Because the said step motor can usually be installed on the periphery of the electronic controller rather than on top of the shock absorber, the present invention can effectively reduce the overall volume and height of the transmission mechanism for electrically controlling the stiffness of automobile and motorcycle shock absorber. This not only reduces the required installation space but also ensures a better usage condition and efficiency. The step motor is connected to the flexible steel wire and propels it to rotate in a preset direction, enabling it to drive the secondary bevel gear. The secondary bevel gear then propels the main bevel gear to rotate in a preset direction, which drives the top of the pressing shaft (31) to rotate inside the main bevel gear and causes it to move relative to the internal regulating system of the shock absorber, thereby adjusting the stiffness of the shock absorber.

Compared to the prior art, in the present invention a flexible steel wire is connected to the step motor to propel the secondary bevel gear and the main bevel gear engaged therewith, which then drive the pressing shaft (31) to move relative to the internal regulating system of the shock absorber, thereby adjusting the stiffness of the shock absorber. In this way the step motor does not have to be installed right on top of the shock absorbing construction, but can be installed in any other location. Compare to the construction therein the step motor is installed right on top of the shock absorber and directly propels the pressing shaft (31), the driving structure in the present invention is markedly reduced in size, with its height reduced from 30-40 mm to 15 mm Saving the installation space for the motor on top of the electric controlled transmission mechanism of the shock absorber, the present invention greatly reduces the required installation space for the shock absorber and notably increases the number of vehicle models that can adopt electronic shock absorber, enhancing its applicability and efficiency.

### BRIEF DESCRIPTION OF THE INVENTION

The technique, device, and effectiveness of the present invention will now be illustrated by way of its preferred embodiment with reference to the accompanying drawings. It is to be understood that the preferred embodiment serves only as an example here and does not limit the scope of the present invention.

FIG. 1 is a schematic representation of the construction of an existing electronic shock absorber;

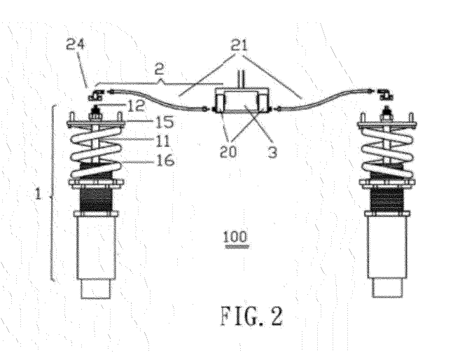

FIG. 2 is a schematic representation of the preferred embodiment of the transmission mechanism for electrically controlling the stiffness of automobile and motorcycle shock absorber according to the present invention;

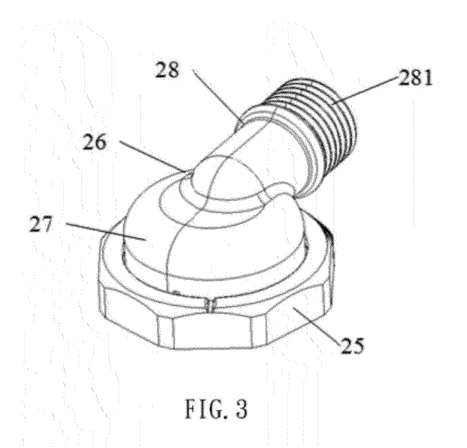

FIG. 3 is a schematic representation of the transmission control component of the transmission mechanism in FIG. 2;

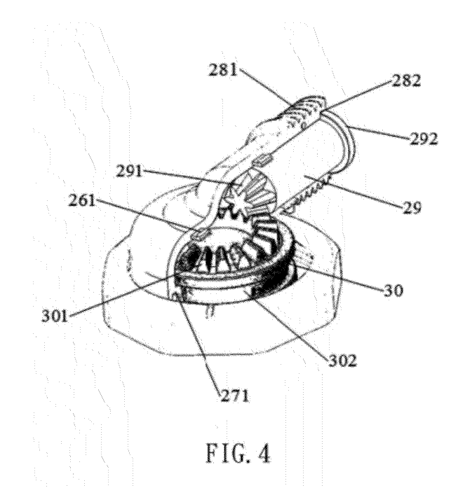

FIG. 4 is a schematic representation of the internal structure of the transmission control component in FIG. 3;

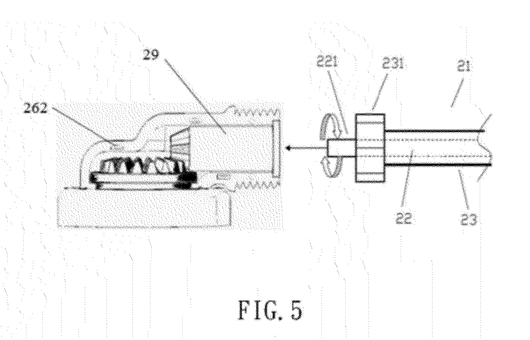

FIG. 5 is a schematic representation of the connection between the transmission control component and the flexible steel wire in the transmission mechanism in FIG. 2;

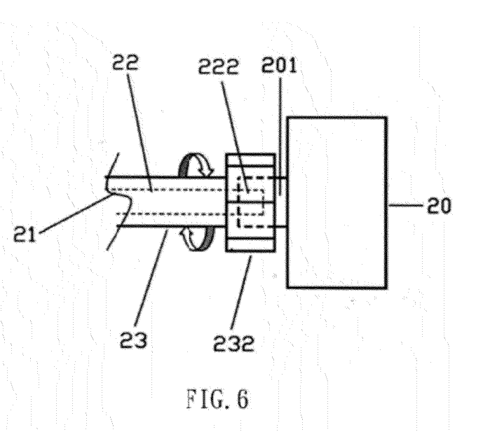

FIG. 6 is schematic representation of the connection between the flexible steel wire and the step motor in the transmission mechanism in FIG. 2.

### DETAILED DESCRIPTION OF THE PREFERRED EMBODIMENT

FIGS. 2 to 6 illustrate the preferred embodiment of the transmission mechanism (100) for electrically controlling the stiffness of automobile and motorcycle shock absorber according to the present invention. Referring first to FIG. 2, the transmission mechanism (100) includes an actuator assembly (1), a transmission assembly (2), and an electronic controller (3). Referring to FIG. 2, the transmission assembly (2) includes a step motor (20), a steel wire assembly (21), and a transmission control component (24).

Turning now to FIG. 3, an enlarged representation of the transmission control component (24) in FIG. 2 is illustrated. The transmission control component (24) includes a fixing nut (25), an outer casing body (26), a secondary bevel gear (29), and a main bevel gear (30). The outer casing body (26) includes a first housing cavity (27) and a second housing cavity (28), which protrudes from the rear and stretches out into the shape of a tube. The first and second housing cavities hold respectively the main bevel gear (30) and the secondary bevel gear (29), which are installed in the outer casing body in the manner that they are engaged with each other and allowed to freely rotate relative to the outer casing body.

The main body of the secondary bevel gear (29) is roughly shaped as a hollow cylinder, on the inside surface of the tail end thereof is disposed a connection slot which can hold one end of the flexible steel wire (22). On the outside of its tail end is disposed a retaining edge (292), so that when the secondary bevel gear (29) is inserted into the prearranged installation position in the second housing cavity (28) of the outer casing body (26), it will be retained by the recess (282) inside the tail end of the second housing cavity (28) of the outer casing body (26) and can freely rotate. The height of the recess (282) is slightly greater than that of the retaining edge (292). The other end of the secondary bevel gear (29) installed in the outer casing body (26) is the bevel gear (291). The upper surface of the main bevel gear (30) contains the bevel gear (301). On the outer surface of the main bevel gear (30) is disposed a circular groove (302), which is to be engaged with the flange (271) on the inside surface of the first housing cavity (27) of the outer casing body (26).

The main idea of this invention is that both the secondary bevel gear (29) and the main bevel gear (30) contain bevel gears (291) and (301) which can be engaged with each other. The secondary bevel gear (29) can rotate on one end of the main bevel gear (30), and being engaged with the main bevel gear (30) the secondary one (29) can drive the main one (30) to rotate. On the inside surface of the hollow main bevel gear (30) are disposed internal spiral threads (not illustrated), which can rotate in coordination with the pressing shaft (11) in the actuator assembly (1).

The outer casing body (26) includes the first housing cavity (27) and the second housing cavity (28), which are inter-connected. On the periphery of the outside surface of the first housing cavity (27) are disposed spiral threads (not illustrated) to be bolted to corresponding ones on the inside surface of the fixing nut (25). On the periphery of the second housing cavity (28) is disposed a steel wire screw lock fixing part (281) to connect the female member of the flexible steel wire (22).

Referring now to FIGS. 4 and 5, the outer casing body (26) contains two combination members. On the joining surface of one of these are disposed some tenons (261), and on the joining surface of the other one are disposed some corresponding grooves (262). For installation, the main bevel gear (30) is first inserted into the first housing cavity (27) of the two-piece outer casing body (26), with the circular groove (302) on the outside surface of the main bevel gear (30) matching the flange (271) on the inside surface of the first housing cavity (27). The secondary bevel gear (29) is then inserted into the second housing cavity (28), with the bevel gear (301) of the main bevel gear (30) matching the bevel gear (291) of the secondary bevel gear (29). The tenons (261)/grooves (262) on the joining surface of one of the combination members of the two-piece outer casing body (26) are wedged with corresponding grooves (262)/tenons (261). The main bevel gear (30) installed in the first housing cavity (27) of the outer casing body (26) can now rotate relative to the secondary bevel gear (29) installed in the second housing cavity (28).

Referring now to FIGS. 4 to 6, the steel wire assembly (21), including a flexible steel wire (22) and a steel wire outer tube (23), is connected with the step motor (20) on one end and the secondary bevel gear (29) on the other. The steel wire outer tube (23) holds the flexible steel wire (22) in the manner that allows the flexible steel wire (22) to freely rotate inside the steel wire outer tube (23). One end of the steel wire outer tube (23) has a steel wire fixing base (231), the inside surface thereof is threaded (not illustrated). These spiral threads coordinate with the steel wire screw lock fixing part (281) on the outside surface of the second housing cavity (28) of the outer casing body (26) to bolt the steel wire outer tube (23) to the outer casing body (26). The first connecting part (221) of the flexible steel wire (22) is inserted into the connection slot from the tail end of the secondary bevel gear (29) and fixed with the secondary bevel gear (29). The first steel wire fixing base (231) is made to butt the tail end of the second housing cavity (28). Because the height of the recess (282) on the inside of the tail end of the second housing cavity (27) is slightly greater than that of the retaining edge (292) on the outside of the tail end of the secondary bevel gear (29), the secondary bevel gear (29) is restrained by the first joint (231) of the steel wire outer tube (23) and can freely rotate in the second housing cavity (27). The other end of the steel wire outer tube (23) has a second steel wire fixing base (232). On the inside surface of this second steel wire fixing base (232) is disposed spiral threads (not illustrated), which coordinate with those (not illustrated) on the outside surface of the joint pole (201) of the step motor (20) to bolt the steel wire outer tube (23) to the step motor (20). The second joint pole (222) of the flexible steel wire (22) is inserted into the step motor (20) and connected with the transmission system.

Preset control data are entered into the electronic controller (3) to control the rotation of the step motor (20). The step motor (20) can usually be installed on the periphery of the electronic controller (3), rather than on top of the transmission mechanism for electrically controlling the stiffness of automobile and motorcycle shock absorber. This reduces the volume and height of the transmission mechanism (100), decreases its required installation space, and ensures a better usage condition and efficiency.

The step motor (20) is set to rotate in a preset direction to drive the flexible steel wire (22) to twirl, which then propel the secondary bevel gear (29) to rotate. The secondary bevel gear (29) drives the main bevel gear (30) to rotate in a preset direction, pushing the top of the pressing shaft (12) inside the main bevel gear (30) to move spirally upward inside the main bevel gear (30) and goes deeper and deeper into it. The fixing nut (25) is moved toward the butting component (15) to push the butting component (15) and drive the resilient element (16) to compress the stored resilience, thereby achieving the purpose of adjusting the stiffness of the electronic transmission mechanism for shock absorber (100).

When the step motor (20) drives the mechanism to rotate in the opposite direction of the preset direction, it can cause the flexible steel wire (22) to twirl and drive the secondary bevel gear (29) to rotate, which propels the main bevel gear (30) to rotate in the opposite direction of the direction in which it will move when the step motor (20) moves the mechanism in the preset direction. The top of the pressing shaft (12) will rotate spirally downwards inside the main bevel gear (30) and move away from the main bevel gear (30). The fixing nut (25) is moved away from the butting component (15), which is oppressed and caused to move by the resilient element (16). The purpose of adjusting the stiffness of the electronic transmission mechanism for shock absorber (100) is achieved when the resilient element (16) is propelled in this manner to stretch and release part of the resilience.

While the invention has been described with reference to a preferred embodiment thereof, it is to be understood that modifications or variations may be easily made without departing from the spirit of this invention, which is defined in the appended claims.

What is claimed is:

1. A transmission mechanism for electrically controlling the stiffness of a vehicle shock absorber, comprising:
an actuator assembly;
an electronic controller; and
a transmission assembly having:
a stepper motor;
a steel wire assembly comprising a flexible steel wire and a steel wire outer tube; and
a transmission control component comprising a fixing nut, an outer casing body installed on the fixing nut, and a secondary bevel gear and a main bevel gear engaged with each other inside the outer casing body;
whereby, the rotation of the step motor is controlled by the electronic controller to drive the flexible steel wire connected to one end with the step motor, the flexible steel wire transmits the rotation of the motor to drive the transmission control component connected to the other end of the flexible steel wire, and the transmission control component drives the actuator assembly.

2. The transmission mechanism for electrically controlling the stiffness of a vehicle shock absorber as defined in claim 1, wherein the outer casing body comprises a first housing cavity and a second housing cavity extending therefrom and formed into the shape of a tube, which two cavities hold respectively the main bevel gear and the secondary bevel gear; wherein the main bevel gear is installed inside the first housing cavity of the outer casing body and is engaged with the secondary bevel gear installed inside the second housing cavity, which two sets of bevel gears are installed in the outer casing body to freely rotate relative to said outer casing body; wherein on the periphery of the outside surface of the first housing cavity are disposed spiral threads to be bolted to corresponding ones on the inside surface of the fixing nut, and on the periphery of the outside surface of the second housing cavity is disposed a screw lock fixing part for a threaded steel wire; and wherein the outer casing body is composed of two combination members which can be joined together, on a joining surface of one thereof are disposed tenons and on the joining surface of the other one thereof are disposed grooves.

3. The transmission mechanism for electrically controlling the stiffness of a vehicle shock absorber as defined in claim 2, wherein on an inside surface of a tail end of the secondary bevel gear is disposed a connection slot to hold one end of the flexible steel wire, and on an outside of the tail end is disposed a retaining edge.

4. The transmission mechanism for electrically controlling the stiffness of a vehicle shock absorber as defined in claim 2, wherein on an upper surface of the main bevel gear is disposed a bevel gear, on an outside surface of the main bevel gear is disposed a circular groove, and on an inside surface of the hollow main bevel gear are disposed internal spiral threads.

5. The transmission mechanism for electrically controlling the stiffness of a vehicle shock absorber as defined in claim 1, wherein the steel wire assembly comprises a flexible steel wire and a steel wire outer tube; wherein the steel wire outer tube holds flexible steel wire, both ends thereof have respectively a first connecting part and a second connecting part; wherein the first connecting part is inserted inside the secondary bevel gear and connected with the secondary bevel gear, and the second connecting part is inserted inside the stepper motor and connected with the transmission system of the motor to freely rotate inside the steel wire outer tube.

6. The transmission mechanism for electrically controlling the stiffness of a vehicle shock absorber as defined in claim 5, wherein one end of the steel wire outer tube has a first steel wire fixing base, on an inside surface thereof are disposed spiral threads which correspond to a steel wire screw lock fixing part on the outside surface of the second housing cavity of the outer casing body to bolt the steel wire outer tube to the outer casing body; and wherein the other end of the steel wire outer tube has a second steel wire fixing base, on an inside surface thereof are disposed spiral threads which correspond to those on an outside surface of a joint pole of the stepper motor to bolt the steel wire outer tube to the stepper motor.
